(19) United States
(12) Patent Application Publication
(10) Pub. No.: US 2026/0186284 A1
(43) Pub. Date: Jul. 2, 2026

(54) LIGHT SHEET MICROSCOPE AND METHOD FOR LIGHT SHEET MICROSCOPY

(71) Applicant: Leica Microsystems CMS GmbH, Wetzlar (DE)

(72) Inventor: Paloma RODRIGUEZ, Wetzlar (DE)

(21) Appl. No.: 19/437,384

(22) Filed: Dec. 31, 2025

(30) Foreign Application Priority Data
Jan. 2, 2025 (DE) 10 2025 100 020.4

(51) Int. Cl. G02B 21/06; H04N 23/74

(52) U.S. Cl. CPC G02B 21/06; H04N 23/74

(57) ABSTRACT

A light sheet microscope includes an illumination system configured to generate a light sheet, and an optical system that includes an objective lens and a detector element. The optical system is configured to illuminate an illumination plane in a sample space via the objective lens using the light sheet, where the illumination plane is oblique with respect to an optical axis of the objective lens. The optical system generates an image of a detection plane in the sample space via the objective lens using the detector element, where the detection plane is oblique with respect to the optical axis of the objective lens. The objective lens includes a correction element configured to be adjustable for correcting aberrations. The light sheet microscope further includes a first adjustment unit, a second adjustment unit, and a controller.

### CROSS REFERENCE TO RELATED APPLICATIONS

This application claims benefit to German Patent Application No. DE 10 2025 100 020.4 filed on Jan. 2, 2025, which is hereby incorporated by reference herein.

### FIELD

The invention relates to a light sheet microscope and to a method for light sheet microscopy.

### BACKGROUND

Light sheet microscopy is a fluorescence imaging technique. In light sheet microscopy, an illumination plane in a sample is illuminated by a thin light sheet arranged perpendicular to the direction of observation. Typically, the light sheet has a thickness of a few hundred nanometers to a few micrometers. Thus, light sheet microscopy allows for optical sectioning of the sample by reducing out-of-focus light, enabling the selective illumination of specific planes within the sample. Further, the amount of incident illumination light which may harm sensitive biological samples can be drastically reduced. Light sheet microscopy combines the benefits of widefield fluorescence imaging as in particular faster imaging speed with an optical sectioning capability known from non-widefield approaches as for example confocal imaging.

### SUMMARY

In an embodiment, the present disclosure provides a light sheet microscope that includes an illumination system configured to generate a light sheet, and an optical system that includes an objective lens and a detector element. The optical system is configured to illuminate an illumination plane in a sample space via the objective lens using the light sheet, where the illumination plane is oblique with respect to an optical axis of the objective lens. The optical system generates an image of a detection plane in the sample space via the objective lens using the detector element, where the detection plane is oblique with respect to the optical axis of the objective lens. The objective lens includes a correction element configured to be adjustable for correcting aberrations. The light sheet microscope further includes a first adjustment unit, a second adjustment unit, and a controller. The first adjustment unit is configured to adjust a position of the illumination plane relative to a sample arranged in the sample space. The second adjustment unit is configured to adjust a position of the detection plane relative to the sample. The controller is configured to control the first adjustment unit, and/or the second adjustment unit based on a current setting of the correction element to align the illumination plane with the detection plane.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic view of a light sheet microscope according to an embodiment; and

FIGS. 2a to 2f are schematic views of a sample space of the light sheet microscope according to FIG. 1, which illustrate a method for light sheet microscopy according to an embodiment.

### DETAILED DESCRIPTION

Embodiments of the present disclosure provide a light sheet microscope and a method for light sheet microscopy, which improve upon known light sheet microscopes and methods.

The proposed light sheet microscope comprises an illumination system configured to generate a light sheet. The light sheet microscope further comprises an optical system comprising an objective lens, and a detector element. The optical system is configured to illuminate an illumination plane in a sample space via the objective lens using the light sheet, the illumination plane being oblique with respect to the optical axis of the objective lens. The optical system is further configured to generate an image of a detection plane in the sample space via the objective lens using the detector element, the detection plane being oblique with respect to the optical axis of the objective lens. The objective lens comprises a correction element configured to be adjustable for correcting aberrations. The light sheet microscope further comprises a first adjustment unit configured to adjust the position of the illumination plane relative to a sample arranged in the sample space, a second adjustment unit configured to adjust the position of the detection plane relative to the sample, and a controller configured to control the first adjustment unit, and/or the second adjustment unit based on a current setting of the correction element to align the illumination plane with the detection plane.

The adjustable correction element enables the correction of aberrations, for example spherical aberrations caused by variations in cover glass thickness or by imaging through optical media having different refractive indices. It has been recognized that adjusting the correction element in a light sheet microscope affects the positions of the illumination plane and the detection plane differently. In a light sheet microscope having a single objective lens facing the sample space, for example, the light sheet is directed into the sample space via a different part of the entrance pupil than detection light received from the sample, which is used to form the image. The proposed light sheet microscope solves this problem, enabling the use of the correction element for correcting aberrations, thereby improving upon known light sheet microscopes.

The first adjustment unit and the second adjustment unit may be used to independently adjust the positions of the illumination plane and the detection plane. The controller may be used to control the first adjustment unit and/or the second adjustment unit to change the positions of the illumination plane and the detection plane relative to the sample. Thereby it is possible to realign the illumination plane with the detection plane after the correction element has been adjusted to correct an aberration. For example, the controller may control the first adjustment unit to move the illumination plane relative to the stationary detection plane, control the second adjustment unit to move the detection plane relative to the stationary illumination plane, or control both the first adjustment unit and the second adjustment unit to move the illumination plane and the detection plane until both planes are aligned. In another example, the controller may control the first adjustment unit and/or the second adjustment unit to change the position of the sample relative to the stationary illumination plane and/or the stationary detection plane.

In an embodiment, the controller is configured to align the illumination plane with the detection plane by making the illumination plane and the detection plane coincident. In this embodiment, the illumination plane and the detection plane are aligned by making them coincident, that is, in the same plane. Thereby, the light sheet illuminates the detection plane, providing optimal illumination of the detection plane for generating the image of the sample. The controller may also be configured to align the illumination plane with the detection plane by making the illumination plane and the detection plane partially coincident, by for example making the illumination plane and the detection plane overlap in an area.

In another embodiment, the controller is configured to control the first adjustment unit and/or the second adjustment unit based on a current setting of the correction element to align a focal point of the illumination plane and a focal point of the detection plane. The focal point of the illumination plane corresponds to the beam waist of the light sheet. The focal point of the detection plane is the point on the optical axis of the objective lens that is focused onto the detector element by the optical system. In this embodiment, the two focal points are aligned. For example, the focal point of the illumination plane and the focal point of the detection plane are brought into close proximity or made to coincide such that the beam waist of the light sheet is close to the focal point of the detection plane, thereby ensuring that the area of the sample that is imaged onto the detector element is optimally illuminated.

In another embodiment, the controller is configured to control the first adjustment unit to align the illumination plane with the detection plane based on at least one predetermined first relationship between a setting of the correction element and a setting of the first adjustment unit. Alternatively, or additionally, the controller is configured to control the second adjustment unit to align the illumination plane with the detection plane based on at least one predetermined second relationship between a setting of the correction element and a setting of the second adjustment unit. The first relationship determines a setting of the first adjustment unit that counteracts the displacement of the illumination plane due to a specific setting of the correction element, for example. Likewise, the second relationship may determine a setting of the second adjustment unit that counteracts the displacement of the detection plane due to a specific setting of the correction element. For example, using the first relationship and/or the second relationship the illumination plane and the detection plane may be aligned based on a position of the correction element. This makes possible a fast alignment of the illumination plane with the detection plane. The first relationship and the second relationship may be a mathematical relationship, or a look-up-table determined in a calibration, for example.

In another embodiment, the controller is configured to control the first adjustment unit based on calibration data. Alternatively, or additionally, the controller is configured to control the second adjustment unit to align the illumination plane with the detection plane based on calibration data. In such an embodiment, the specifics of the individual light sheet microscope are taken into account in the control of the first adjustment unit and/or the second adjustment unit. Thereby, alignment of the illumination plane with the detection plane can be performed very precisely. The calibration data may be determined in advance by a manufacturer of the light sheet microscope, for example. However, the calibration data may also be determined and/or updated by a user. The calibration data is stored in the form of a look-up-table, for example.

In another embodiment, the controller is configured to control the first adjustment unit and/or the second adjustment unit to align the illumination plane with the detection plane based on the image of the detection plane generated by the optical system. For example, the controller may be configured to determine an image quality of an image generated by the optical system, and to control the first adjustment unit and the second adjustment unit to align the illumination plane with the detection plane based on the determined image quality. This enables a precise alignment of the illumination plane, and the detection plane based on the current conditions in the sample space and/or a body of the light sheet microscope, for example. In some embodiments, the controller may be configured to perform an iterative process to align the illumination plane with the detection plane. The iterative process may comprise controlling the optical system to acquire images before and after adjusting the position of the illumination plane and/or the detection plane relative to the sample, determine an image quality for each of the images, and adjusting the position of the illumination plane and/or the detection plane relative to the sample based on the determined image qualities.

In another embodiment, the controller is configured to control the first adjustment unit and/or the second adjustment unit to align the illumination plane with the detection plane when the correction element has been adjusted. In such an embodiment, whether the correction element has been adjusted may be seen as the setting of the correction element the control the first adjustment unit and/or the second adjustment unit is based on. The illumination plane and the detection plane may be aligned automatically, for example, when the correction element has been adjusted. In some embodiments, the user may be asked whether the illumination plane and the detection plane should be realigned when the correction element has been adjusted. For example, the controller may be configured to generate such an output and to receive a user input corresponding to the user's reply.

In another embodiment, the optical system comprises a detection beam path comprising the detector element, an illumination beam path comprising the illumination system, and a beam combining element, configured to combine the detection beam and the illumination beam into a main beam path comprising the objective lens. The beam combining element may be a beam splitter, for example, such as a dichroic beam splitter or an acousto-optical beam splitter.

In some embodiments, the light sheet microscope may comprise an intermediate image space and an optical relay system. In such embodiments, the illumination system may be configured to generate a light sheet in the intermediate image space and the optical relay system may be configured to image the light sheet into the sample. The optical relay system may further be configured to image detection light coming from the sample into the intermediate image space. Such embodiments may further comprise an optical detection system which images detection light from the intermediate image space onto the detector element. In such embodiments, the intermediate image space may be seen as the beam combining element since it combines the illumination beam path comprising the illumination system and the detection beam path comprising the detector element and the optical detection system. The optical relay system may comprise two objective lenses, a first objective lens being directed at the sample space, and a second objective lens being directed at the intermediate image space. Either the first objective lens or the second objective lens may comprise the correction element.

In another embodiment, the first adjustment unit comprises at least one first motor configured to move at least one first optical element arranged in the illumination beam path. Moving the optical element in the illumination beam path changes, for example, the focal length along the illumination beam path. Thereby, the position of the illumination plane is changed relative to the fixed sample. This makes it possible to align the position of the illumination plane relative to the sample without moving the sample itself. Likewise, the second adjustment unit may comprise at least one second motor configured to move at least one second optical element arranged in the detection beam path. Thereby it is possible to align the position of the detection plane relative to the sample without moving the sample itself. The first optical element and the second optical may each be a lens, a group of lenses, a mirror, or another reflecting element, for example.

In another embodiment, the first adjustment unit and/or the second adjustment unit comprise a third motor configured to move the objective lens along its optical axis. In such an embodiment, the objective lens may be moved to change the position of the focal point of the illumination plane and/or the focal point of the detection plane. Thereby, the position of the illumination plane and/or the detection plane, respectively, is changed relative to the sample. In some embodiments, this may change the position of the illumination plane and the detection plane in similar ways, allowing both planes to be coarsely repositioned relative to the sample before aligning the planes individually, for example.

In another embodiment, the first adjustment unit and/or the second adjustment unit comprise a motorized microscope stage on which the sample is arranged, and which is configured to be moveable along the optical axis of the objective lens. In this embodiment, the sample may be moved relative to the stationary illumination plane and/or the stationary detection plane. Thereby, the position of the illumination plane and/or the detection plane may be changed relative to the sample. The motorized microscope stage may also be configured to be moveable in x-y-directions, and may further be configured to be rotatable, for example around the optical axis of the objective lens.

In another embodiment, the correction element is adjustable via a correction collar. The correction collar may be an adjustable ring around the objective lens, for example, that provides ergonomic and intuitive control for adjusting the correction element. The correction collar may be motorized and/or manually operable.

The present disclosure further relates to a method for light sheet microscopy. The method comprises at least the following steps: Illuminating an illumination plane in a sample space via an objective lens using a light sheet, the illumination plane being oblique with respect to the optical axis of the objective lens. Generating an image of a detection plane in the sample space via the objective lens, the detection plane being oblique with respect to the optical axis of the objective lens. The method further comprises adjusting a correction element for correcting an aberration, and aligning the illumination plane with the detection plane based on a current setting of the correction element.

The method has the same advantages as the light sheet microscope described above. In particular, the method may be supplemented with the features described in this document in connection with the light sheet microscope. Furthermore, the controller and the light sheet microscope described above may be supplemented with the features described in this document in connection with the method.

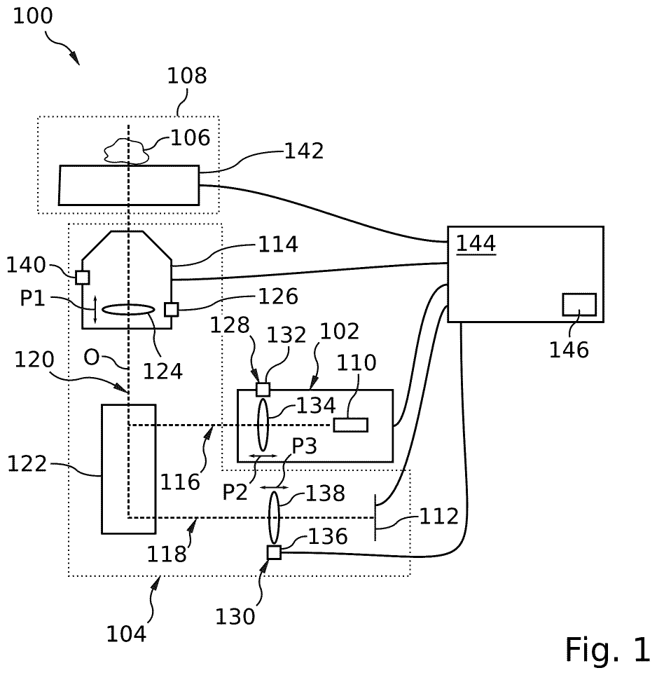

FIG. 1 is a schematic view of a light sheet microscope 100 according to an embodiment. The light sheet microscope 100 comprises an illumination system 102 and an optical system 104. A sample 106 to be observed with the light sheet microscope 100 is arranged in a sample space 108 of the light sheet microscope 100.

The illumination system 102 is configured to generate a light sheet for illuminating a section of the sample 106. To generate the light sheet, the illumination system 102 exemplary comprises an illumination light source 110 configured to generate illumination light, for example laser light. In other embodiments, the illumination light may be generated externally, for example by an external laser light source, and coupled into the light sheet microscope 100. In some embodiments, the illumination system 102 may comprise a cylindrical lens for forming the light sheet from the illumination light. In other embodiments, the illumination system 102 may generate a quasi-static light sheet from the illumination light by means of a dedicated scanning element.

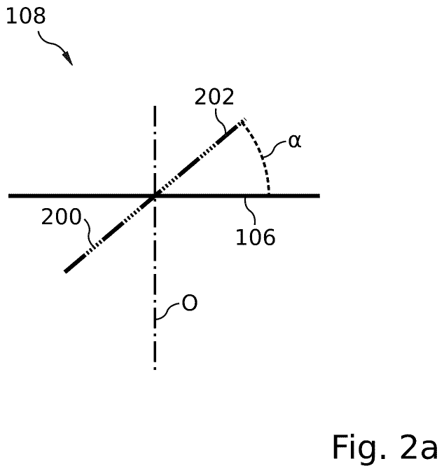

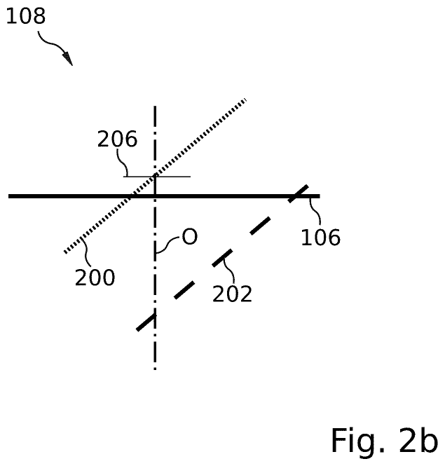

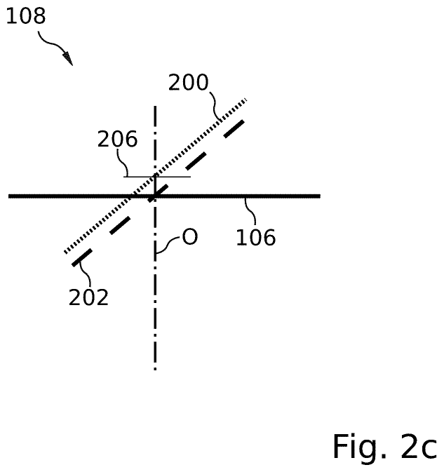

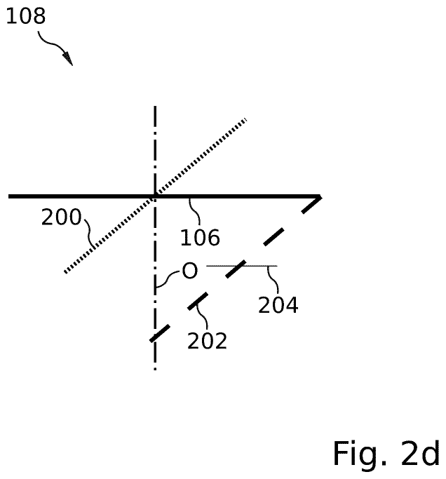

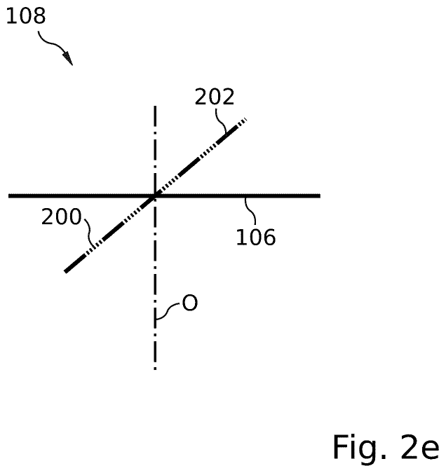

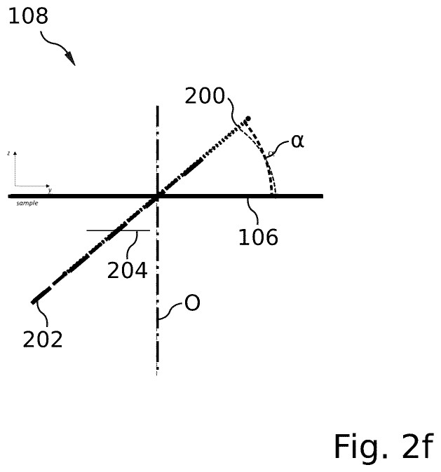

The optical system 104 is configured to illuminate an illumination plane 200 in the sample space 108 using the light sheet, and to image a detection plane 202 in the sample space 108 using a detector element 112. The illumination plane 200 and the detection plane 202 are shown in FIGS. 2a to 2f. In the present embodiment, the optical system 104 comprises a single objective lens 114 directed at the sample space 108. The objective lens 114 is used for both illuminating the sample 106 and for receiving detection light from the sample 106 from which the image of the detection plane 202 is generated. Both the illumination plane 200 and the detection plane 202 are oblique with respect to an optical axis O of the objective lens 114. An illumination beam path 116 of the optical system 104 starts at the illumination light source 110. A detection beam path 118 of the optical system 104 starts at the detector element 112. The illumination beam path 116 and the detection beam path 118 are combined into a main beam path 120 by a beam combining element 122, for example a beam splitter or an intermediate image space.

The objective lens 114 comprises a correction element 124 that can be adjusted for correcting aberrations, for example spherical aberrations. In FIG. 1, the correction element 124 is exemplary formed as a lens which is movable along the optical axis O of the objective lens 114. The movement of the lens is indicated in FIG. 1 by a first double-headed arrow P1. Adjustment of the correction element 124 is facilitated by a control element such as a correction collar 126 as is shown in FIG. 1. The correction collar 126 enables manual adjustment of the correction element 124. In some embodiments, the adjustment of the correction element 124 may also be motorized. Adjusting the correction element 124 affects the position of the illumination plane 200 and the position of the detection plane 202. In particular, both planes 200, 202 are affected differently. This means that adjusting the correction element 124 may lead to the illumination plane 200 and the detection plane 202 moving away from each other. However, in order to generate a good image of the sample 106, the illumination plane 200 and the detection plane 202 need to be aligned, for example brought into close proximity or made to coincide. When the illumination plane 200 is aligned with the detection plane 202, the detection plane 202 is optimally illuminated by the light sheet.

For aligning the illumination plane 200 with the detection plane 202, the light sheet microscope 100 comprises a first adjustment unit 128 and second adjustment unit 130. The first adjustment unit 128 is configured to adjust the position of the illumination plane 200 relative to the sample 106. In the present embodiment, the first adjustment unit 128 exemplary comprises a first motor 132 configured to move a first optical element 134 arranged in the illumination beam path 116. The movement of the first optical element 134 is indicated in FIG. 1 by a second double-headed arrow P2. In FIG. 1, the first optical element 134 is exemplary arranged as part of the illumination system 102. The second adjustment unit 130 is configured to adjust the position of the detection plane 202 relative to the sample 106. In the present embodiment, the second adjustment unit 130 exemplary comprises a second motor 136 configured to move a second optical element 138 arranged in the detection beam path 118. The movement of the second optical element 138 is indicated in FIG. 1 by a third double-headed arrow P3. By using the movement of the first optical element 134 arranged in the illumination beam path 116, the position of the illumination plane 200 may be adjusted independently of the position of the detection plane 202. Likewise, by using the movement of the second optical element 138 arranged in the detection beam path 118, the position of the detection plane 202 may be adjusted independently of the position of the illumination plane 200.

In some embodiments, the first adjustment unit 128 and/or the second adjustment unit 130 may comprise a third motor 140 arranged and configured to move the objective lens 114 along its optical axis O. Moving the objective lens 114 along its optical axis O may change the position of the focal point of the objective lens 114, and thus the position of the illumination plane 200 and/or the detection plane 202. In yet another embodiment, the first adjustment unit 128 and/or the second adjustment unit 130 may comprise a motorized microscope stage 142 on which the sample 106 is arranged. By moving the microscope stage 142, the sample 106 is moved while the illumination plane 200 and the detection plane 202 remain stationary. However, the positions of the illumination plane 200 and the detection plane 202 are changed relative to the sample 106.

The light sheet microscope 100 further comprises a controller 144. The controller 144 is configured to control the light sheet microscope 100. In particular, the controller 144 is configured to control the first adjustment unit 128 and/or the second adjustment unit 130 for aligning the illumination plane 200 with the detection plane 202 based on a current setting of the correction element 124. In some embodiments, the controller 144 may be configured to perform a method for light sheet microscopy. The method comprises adjusting the correction element 124 for correcting an aberration and aligning the illumination plane 200 with the detection plane 202 based on a current setting of the correction element 124. The process of aligning the illumination plane 200 with the detection plane 202 will be described in more detail below with reference to FIGS. 2a to 2f. In yet other embodiments, the controller 144 may comprise a memory element 146 configured to store data related to the control of the first adjustment unit 128 and the second adjustment unit 130. For example, the memory element 146 may store calibration data, which relates a setting of the correction element 124 to settings of the first adjustment unit 128 and/or the second adjustment unit 130. The calibration data may be determined in a calibration step of the method.

In FIG. 1, the correction element 124 is exemplary shown as part of the objective lens 114, which is directed at the sample space 108. However, in some embodiments, the correction element 124 may also be part of an objective lens directed at an intermediate image space, said objective lens being, for example, part of an objective lens of an optical relay system arranged as part of the main beam path 120, an optical detection system which also comprises the detector element 112, or the illumination system 102.

FIGS. 2a to 2f are schematic views of the sample space 108 of the light sheet microscope 100 according to FIG. 1. The FIGS. 2a to 2f illustrate different steps of the method for light sheet microscopy according to an embodiment. In FIGS. 2a to 2f, the sample 106 is shown as a solid line, the illumination plane 200 is shown as a dashed line, the detection plane 202 is shown as a dotted line, and the optical axis O of the objective lens 114 is shown as a dash-dotted line. The optical axis O is perpendicular to the sample 106, and, as can be seen in FIG. 2a, the illumination plane 200 and the detection plane 202 are tilted with respect to the sample 106 by a non-zero angle α. Thus, the illumination plane 200 and the detection plane 202 enclose an angle of 90°-α with the optical axis O, meaning that the two planes 200, 202 are oblique with respect to the optical axis O. A focal point 204 of the illumination plane 200, that is the focal point along the illumination beam path 116, is indicated as a horizontal dotted line in FIGS. 2b to 2f. Likewise, a focal point 206 of the detection plane 203, that is the focal point along the detection beam path 118, is indicated as a horizontal dotted line in FIGS. 2b to 2f.

FIG. 2a shows an initial situation, before the correction element 124 is adjusted. As can be seen in FIG. 2a, before the correction element 124 is adjusted, the illumination plane 200 is aligned with the detection plane 202 aligned. In particular, the focal point 204 of the illumination plane 200 and the focal point 206 of the detection plane 202 overlap in the sample 106. FIG. 2b shows the situation after the correction element 124 has been adjusted, for example to correct for a spherical aberration. As can be seen in FIG. 2b, this shifts the positions of the illumination plane 200 and the detection plane 202 in different ways. The illumination plane 200 is moved to the bottom right in FIG. 2b compared to its original position shown in FIG. 2a, while the detection plane 202 is moved to the top left in FIG. 2b. In some embodiments, the controller 144 may detect that the correction element 124 has been adjusted and may automatically initiate the realignment of the illumination plane 200 with the detection plane 202. The controller 144 may further be configured to perform an iterative process as part of the method to align the illumination plane 200 and the detection plane 202, for example an iterative process based on images captured by the optical system 104.

FIG. 2c shows the situation after only the position of the illumination plane 200 has been adjusted. As can be seen in FIG. 2c, the illumination plane 200 is back at its original position shown in FIG. 2a. The position of the detection plane 202 has not been adjusted. The detection plane 202 remained stationary while the illumination plane 200 was moved. Likewise, FIG. 2d shows the situation after only the position of the detection plane 202 has been adjusted. In the situation shown in FIG. 2d, the detection plane 202 is back at its original position shown in FIG. 2a while the illumination plane 200 has remained stationary.

FIG. 2e shows the situation in which the positions of both the illumination plane 200 and the detection plane 202 have been adjusted to realign the two planes 200, 202. In FIG. 2e, the two planes 200, 202 have been aligned by making the focal points 204, 206 of the illumination plane 200 and the detection plane 202 coincide with the position of the sample 106. In other embodiments, the illumination plane 200 may be aligned with the detection plane 202 by bringing the focal points 204, 206 in close proximity instead. FIG. 2f shows yet another possibility of how the illumination plane 200 and the detection plane 202 may be aligned. In FIG. 2f the illumination plane 200 and the detection plane 202 coincide, but the focal points 204, 206 are arranged at different positions along the optical axis O, i.e. different z-positions. Only the focal point 206 of the detection plane 202 is aligned with the sample 106.

Identical or similarly acting elements are designated with the same reference signs in all Figures. As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### Reference Signs

100 Light sheet microscope

102 Illumination system

104 Optical system

106 Sample

108 Sample space

110 Illumination light source

112 Detector element

114 Objective lens

116 Illumination beam path

118 Detection beam path

120 Main beam path

122 Beam combining element

124 Correction element

126 Correction collar

128, 130 Adjustment unit

132 Motor

134 Optical element

136 Motor

138 Optical element

140 Motor

142 Memory element

200 Illumination plane

202 Detection plane

204, 206 Focal point

O Optical axis

P1, P2, P3 Arrow

1. A light sheet microscope, comprising:
an illumination system configured to generate a light sheet, and
an optical system comprising an objective lens, and a detector element,
wherein the optical system is configured to:
illuminate an illumination plane in a sample space via the objective lens using the light sheet, wherein the illumination plane is oblique with respect to an optical axis of the objective lens, and
generate an image of a detection plane in the sample space via the objective lens using the detector element, wherein the detection plane is oblique with respect to the optical axis of the objective lens,
wherein the objective lens comprises a correction element configured to be adjustable for correcting aberrations, and wherein the light sheet microscope further comprises:
a first adjustment unit configured to adjust a position of the illumination plane relative to a sample arranged in the sample space,
a second adjustment unit configured to adjust a position of the detection plane relative to the sample, and
a controller configured to control the first adjustment unit, and/or the second adjustment unit based on a current setting of the correction element to align the illumination plane with the detection plane.

2. The light sheet microscope according to claim 1, wherein the controller is further configured to align the illumination plane and the detection plane by making the illumination plane with the detection plane coincident, partially coincident, and/or overlap.

3. The light sheet microscope according to claim 1, wherein the controller is further configured to control the first adjustment unit and/or the second adjustment unit based on the current setting of the correction element to align a focal point of the illumination plane and a focal point of the detection plane.

4. The light sheet microscope according to claim 1, wherein the controller is further configured to control the first adjustment unit to align the illumination plane with the detection plane based on at least one predetermined first relationship between a setting of the correction element and a setting of the first adjustment unit; and/or to control the second adjustment unit to align the illumination plane with the detection plane based on at least one predetermined second relationship between the setting of the correction element and a setting of the second adjustment unit.

5. The light sheet microscope according to claim 1, wherein the controller is further configured to control the first adjustment unit and/or the second adjustment unit to align the illumination plane with the detection plane based on calibration data.

6. The light sheet microscope according to claim 1, wherein the controller is further configured to control the first adjustment unit and/or the second adjustment unit to align the illumination plane with the detection plane based on the image of the detection plane generated by the optical system.

7. The light sheet microscope according to claim 1, wherein the controller is further configured to control the first adjustment unit and/or the second adjustment unit to align the illumination plane with the detection plane when the correction element has been adjusted.

8. The light sheet microscope according to claim 1, wherein the optical system further comprises a detection beam path comprising the detector element, an illumination beam path comprising the illumination system, and a beam combining element, configured to combine a detection beam and an illumination beam into a main beam path comprising the objective lens.

9. The light sheet microscope according to claim 8, wherein the first adjustment unit comprises at least one first motor configured to move at least one first optical element arranged in the illumination beam path.

10. The light sheet microscope according to claim 8, wherein the second adjustment unit comprises at least one second motor configured to move at least one second optical element arranged in the detection beam path.

11. The light sheet microscope according to claim 1, wherein the first adjustment unit and/or the second adjustment unit comprise a third motor configured to move the objective lens along the optical axis.

12. The light sheet microscope according to claim 1, wherein the first adjustment unit and/or the second adjustment unit comprise a motorized microscope stage on which the sample is arranged, and which is configured to be moveable along the optical axis of the objective lens.

13. The light sheet microscope according to claim 1, wherein the correction element is adjustable via a correction collar.

14. A method for light sheet microscopy, the method comprising:
illuminating an illumination plane in a sample space via an objective lens using a light sheet, the illumination plane being oblique with respect to an optical axis of the objective lens;
generating an image of a detection plane in the sample space via the objective lens, the detection plane being oblique with respect to the optical axis of the objective lens;
adjusting a correction element for correcting an aberration, and
aligning the illumination plane with the detection plane based on a current setting of the correction element.
